(19) United States
(12) Patent Application Publication
(10) Pub. No.: US 2016/0275454 A1
(43) Pub. Date: Sep. 22, 2016

(54) Populating Forms for Electronic Signature on a Mobile Device

(71) Applicants: Alexander Shiryaev, Izhevsk (RU); Pavel Kultyshev, Izhevsk (RU); Artem Trifonov, Izhevsk (RU)

(72) Inventors: Alexander Shiryaev, Izhevsk (RU); Pavel Kultyshev, Izhevsk (RU); Artem Trifonov, Izhevsk (RU)

(21) Appl. No.: 14/660,612

(22) Filed: Mar. 17, 2015

(51) Int. Cl. G06Q 10/10; G06F 17/24

(52) U.S. Cl. CPC G06Q 10/1053; G06F 17/243

(57) ABSTRACT

Techniques for simplifying the process of entering data into forms such as employment forms. A new hire can be examined to determine the employment forms that the new hire needs to complete before beginning employment. The employment forms can be examined to determine the new hire data is to be collected from the new hire. Based on the examination, one or more mobile panels are identified. Each mobile panel includes one or more fields configured to collect personal information from the new hire. The mobile panels are presented to the new hire who in turn enters their personal information into the mobile forms. The new hire data entered into the mobile forms can then be used to populate the employment forms. Once the employment forms are populated, they can be transmitted to the new hire for review. In some instances, the new hire can electronically sign the employment forms.

### BACKGROUND

During the onboarding process, a new hire has to complete many employment forms. For example, 1-9 forms need to be properly completed for employment eligibility verification. The employment forms contain many fields that need to be filled out with personal information. In some scenarios, the employment forms can require copies of identification documents. Many of the employment forms can contain redundant fields. As a result, the new hire has to enter the same personal information multiple times. This is cumbersome and error prone. Differences in formatting within employment forms can also make it difficult for a new hire to complete all the employment forms since there is no consistency between the forms. As a result, the new hire can spend an exorbitant amount of time filling out employment forms.

### SUMMARY

In one embodiment, a computer-implemented method receives, by a processor, a request to complete at least one employment form associated with an employee. The method then identifies, by the processor, a mobile panel configured to receive employee data that is associated with the employee. The method then transmits, by the processor, the mobile panel to a mobile device operated by the employee. The method then receives, by the processor, the employee data through the mobile panel. The method then populates, by the processor, the at least one employment form with the employee data. The method then renders, by the processor, the at least one populated employment form into at least one rendered image. The method then transmits, by the processor, the at least one rendered image to the mobile device operated by the employee.

In one example, the method can further receive, by the processor, an electronic signed copy of the at least one rendered image and associate, by the processor, the electronic signed copy of the at least one rendered image to an employee account of the employee.

In another example, the request is generated from the selection of a link provided in an email.

In another example, identifying the panel can include identifying, by the processor, an empty field within an employment form of the at least one employment form an determining, by the processor, the mobile panel includes a field for receiving the employee data that corresponds with the empty field within the employment form.

In another example, the method can further include matching, by the processor, the employee data to another employment form and populating, by the processor, the employee data within the another employment form.

In another example, the method can further include storing, by the processor, the employee data within a data structure associated with the employee.

In another example, at least one field within the mobile panel is prepopulated with information available on the employee.

In another embodiment, a non-transitory computer readable storage medium stores one or more programs comprising instructions for receiving a request to complete at least one employment form associated with an employee, identifying a mobile panel configured to receive employee data that is associated with the employee, transmitting the mobile panel to a mobile device operated by the employee, receiving the employee data through the mobile panel, populating the at least one employment form with the employee data, rendering the at least one populated employment form into at least one rendered image, and transmitting the at least one rendered image to the mobile device operated by the employee.

In another embodiment, a computer implemented system comprises one or more computer processors and a non-transitory computer-readable storage medium. The non-transitory computer-readable storage medium comprises instructions, that when executed, control the one or more computer processors to be configured for receiving a request to complete at least one employment form associated with an employee, identifying a mobile panel configured to receive employee data that is associated with the employee, transmitting the mobile panel to a mobile device operated by the employee, receiving the employee data through the mobile panel, populating the at least one employment form with the employee data, rendering the at least one populated employment form into at least one rendered image, and transmitting the at least one rendered image to the mobile device operated by the employee.

The following detailed description and accompanying drawings provide a better understanding of the nature and advantages of the present disclosure.

### BRIEF DESCRIPTION OF THE DRAWINGS

FIG. 1 illustrates a system for populating employment forms according to one embodiment;

FIG. 2 illustrates a system for generating mobile panels according to one embodiment;

FIG. 3 illustrates a system for processing an onboarding request for a new hire according to one embodiment;

FIG. 4 illustrates an exemplary data structure for storing employee information within an employee database according to one embodiment;

FIG. 5 illustrates a system for generating onboarding forms according to one embodiment;

FIG. 6 illustrates a technique for populating data fields within mobile panels to onboarding forms according to one embodiment;

FIG. 7 illustrates a mobile panel designer window according to one embodiment;

FIG. 8 illustrates a new hire onboarding wizard window according to one embodiment;

FIG. 9 illustrates a summary page of the new hire onboarding wizard according to one embodiment;

FIG. 10 illustrates an introduction email according to one embodiment;

FIG. 11 illustrates a mobile panel according to one embodiment; and

FIG. 12 illustrates an exemplary computer system according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

Described herein are techniques for simplifying the process of entering data into forms. While the techniques describe the process of entering new hire information into employment forms for purposes of onboarding, it is to be understood by those of skill in the art that the techniques here have many other applications. For example, the techniques can be applied to simplify the process of entering data into other types of forms such as sales forms, order forms, and other standardized forms. In some embodiments, new hire information can be entered into panels. Each panel can have one or more fields configured to receive data. The data entered into a field can be populated into one or more employment forms. This can reduce the time spent entering data into employment forms since common data (such as name and address) can be entered just once and distributed into many employment forms. This technique can also reduce the chance of error since the same data is being entered once rather than multiple times.

The system can be implemented on the client side or server side. For example, the system can be implemented on the client device and be configured to populate employment forms using user input received in one or more panels on the client device. As another example, the system can be implemented on a server that is in communication with a client device. The server can generate one or more panels to be presented on the client device. User input received on the client device can be populate the one or more panels with data. The data can in turn be transmitted from the client device to the server. The server can process the data to populate one or more employment forms. Once the employment forms are populated, the server can transmit the populated electronic forms to the client device. The new hire can examine the employment forms for accuracy and optionally, apply an electronic signature by using the client device. Once the employment forms are approved, the client device can transmit an approval signal to the server or the employment forms with electronic signatures.

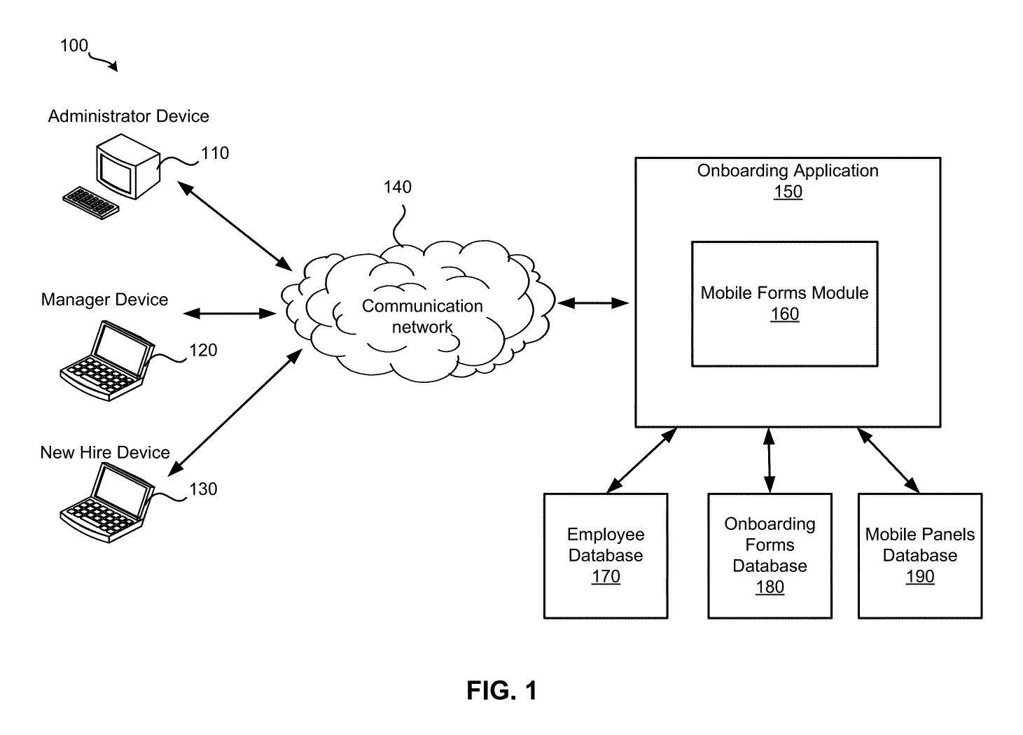

FIG. 1 illustrates a system for populating employment forms according to one embodiment. System 100 includes administrator device 110, manager device 120, and new hire device 130. These three devices can be mobile devices or non-mobile devices. Each device can communicate with onboarding application 150 through communication network 140. Administrator device 110 can communicate with onboarding application 150 to generate mobile panels. Each mobile panel can be configured to be presented on a mobile or non-mobile device. In one example, a mobile panel can be configured to be presented using a web browser application. In another example, a mobile panel can be configured to be presented on a dedicated application that can be executed on one or more of the devices.

Manager device 120 can communicate with onboarding application 150 to schedule one or more onboarding tasks for a new hire. The onboarding tasks can include the filling out of one or more employment forms which are to be filled out and signed before the new hire can begin working within the organization. The employment forms can be used to ensure that the new hire is aware of practices and rules of the organization by having the new hire review the employment forms and sign stating that the forms have been reviewed. The employment forms can also be used to receive personal information of the new hire. The new hire may be required to sign the employment form stating that the personal information entered is accurate to the knowledge of the new hire. For example, the employment forms can ask for personal information of the new hire such as legal name, home address, and bank account information. In one embodiment, manager device 120 can request that particular onboarding forms be filled out for a new hire. The onboarding forms can include one or more fields which request personal information of the new hire. Based on the onboarding forms, onboarding application 150 can select one or more panels which are configured to request personal information from the new hire to be used to populate the onboarding forms. The one or more panels can be configured to request the personal information from the new hire which is required by the onboarding forms but is not readily available to onboarding application 150. In another embodiment, onboarding application 150 can automatically determine the particular onboarding forms for a new hire based on the position and role of the new hire, the business unit which the new hire is joining, or the geographical location of the new hire. Based on the onboarding forms, onboarding application 150 can select mobile panels to present to a new hire. In yet another embodiment, onboarding application 150 can receive instruction from manager device 120 to present one or more mobile panels to the new hire. Thus, the mobile panels can be manually selected.

New hire device 130 can be configured to receive mobile panels from onboarding application 150. Each mobile panel can include one or more fields for receiving personal information from the new hire operating new hire device 130. The mobile panels can be presented using a mobile browser or a dedicated application running on new hire device 130. Using new hire device 130, the new hire can provide personal information within the fields of a mobile panel. Personal information provided can be transmitted from new hire device 130 to onboarding application 150. In one embodiment, onboarding application 150 can store the personal information within databases accessible to onboarding application 150. In another embodiment, onboarding application 150 can utilize the personal information to populate one or more onboarding forms that are to be filled out by the new hire. Thus, the new hire is entering the personal information into the mobile panels rather than the onboarding forms. Entering the personal information into the mobile panels rather than the onboarding forms has certain advantages. One advantage is that common personal information such as name and home address which are fields in many onboarding forms can be entered once rather than multiple times. Another advantage is that common personal information can be validated for formatting or content through logic in the mobile panel. Once the onboarding forms are populated, onboarding application 150 can transmit the populated onboarding forms to new hire device 150 for review.

Onboarding application 150 includes mobile forms module 160. Mobile forms module 160 is configured to populate onboarding forms through the use of mobile panels.

Mobile forms module 160 can interface with employees database 170 (which contains personal information that is available on employees and new hires plus a list of onboarding requirements), onboarding forms database (which contains a database of onboarding forms), and mobile panels database (which contains a database of mobile panels which can be used to collect personal information on new hires for purposes of onboarding).

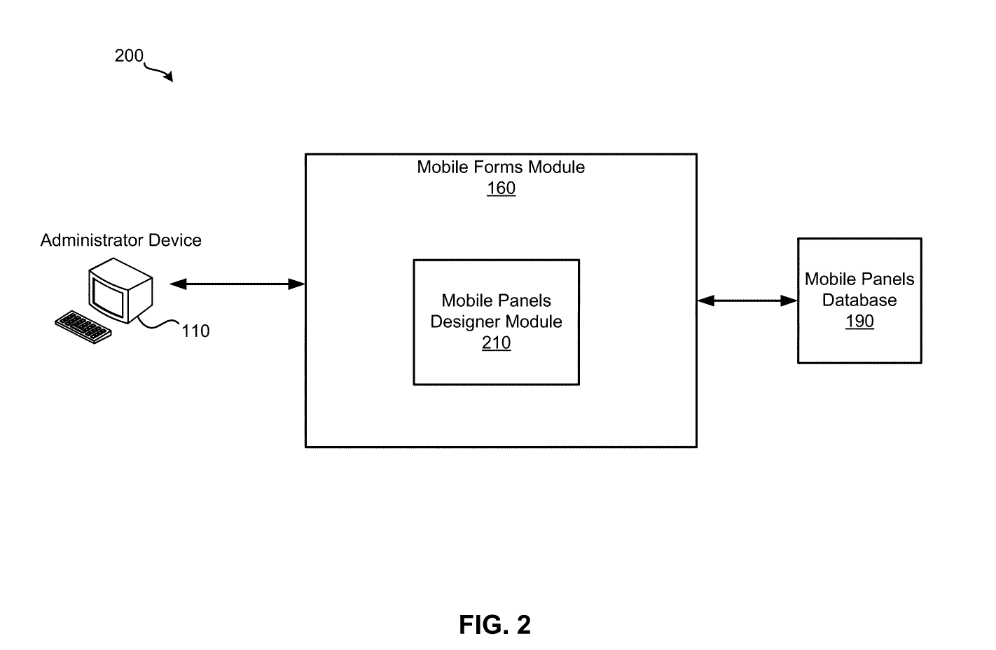

FIG. 2 illustrates a system for generating mobile panels according to one embodiment. As shown, system 200 includes administrator device 110, mobile forms module 160, and mobile panels database 190. Mobile forms module 160 includes mobile panels designer module 210 which is configured for generating mobile panels. As described above, a mobile panel can collect personal information from a new hire to be populated into one or more onboarding forms. In other embodiments, a mobile panel can collect other information from a user. The personal information collected can be in the form of text, images, and attached documents. Mobile panels design module 210 can process user input received from administrator device 110 to generate a mobile panel. For example, the user input can specify the data and information which is to be collected by the mobile panel. The data and information can be entered into fields of the mobile panel. In one embodiment, the mobile panel can include logic to alter the appearance of the mobile panel. For example, the logic can change the fields presented on the mobile panel based on data previously entered into the mobile panel. For instance, a mobile panel to collect 1-9 information to verify employment eligibility can request one of three types of documents to prove employment eligibility. The mobile panel can include a field for the new hire to select which type of document he or she would like to provide. Based on the selection, logic in the mobile panel can alter other fields in the mobile panel to collect the type of document.

A mobile panel generated by mobile panels designer module 210 can be stored within mobile panels database 190. The mobile panel can subsequently be selected by managers to collect personal information from new hires and can be presented to new hires for purposes of collecting personal information.

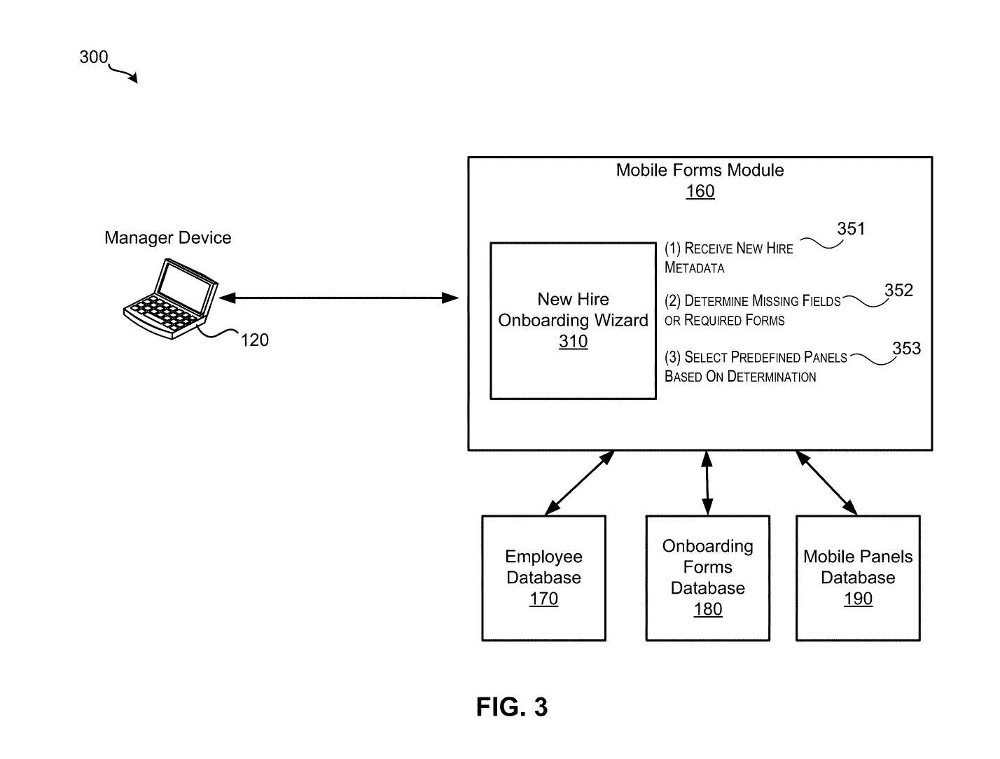

FIG. 3 illustrates a system for processing an onboarding request for a new hire according to one embodiment. System 300 includes manager device 120, mobile forms module 160, employee database 170, onboarding forms database 180, and mobile panels database 190. Mobile forms module 160 includes new hire onboarding wizard 310. New hire onboarding wizard 310 is configured to set up an onboarding program for the new hire.

In one embodiment, a manager operating manager device 120 can utilize new hire onboarding wizard 310 to configure an onboarding program for a new hire. The onboarding program can include one or more mobile panels. Each mobile panel can have fields which can be populated with data which is subsequently used to populate onboarding forms for the new hire. Required onboarding forms that need to be filled out by the new hire can be specified by the manager. Based on the required onboarding forms, new hire onboarding wizard 310 can determine what data is needed from the new hire to complete the required onboarding forms. New hire onboarding wizard 310 can select mobile panels which can subsequently be presented to the new hire to collect the missing data.

As shown here, new hire onboarding wizard 310 can begin by receiving new hire metadata at step (1) (reference numeral 351). The new hire metadata can include a new hire identifier that uniquely identifies the new hire. For example, new hire onboarding wizard 310 can receive from manager device 120 the legal name of the new hire or an employee ID associated with the new hire. New hire onboarding wizard 310 can query employee database 170 to determine new hire data that is missing in employee database 170 or the onboarding forms which are required for the new hire at step (2) (reference numeral 352). In one embodiment, new hire onboarding wizard 310 determines the missing new hire data that needs to be collected from the new hire. The new hire data can include personal information which has not been provided by the new hire. For example, social security number, home address, work history, and skill set can be missing from employee database 170. New hire onboarding wizard 310 can select one or more predefined mobile panels to present to the new hire based on the missing new hire data at step (3) (reference numeral 352). The mobile panels can include fields configured for collecting the missing new hire data. In one example, new hire onboarding wizard 310 can examine the mobile panels in mobile panels database 190 to identify one or more mobile panels which contain fields to request the missing new hire data. In some instances, there is some redundancy in the fields within different mobile panes so mobile panels database 190 can identify the least number of mobile panels which are needed to request the missing new hire data.

In another embodiment, new hire onboarding wizard can determine the required onboarding forms from the role of the new hire or the position of the new hire at step (2) (reference numeral 352). In one example, new hire onboarding wizard 310 can determine the new hire's position within the organization based on metadata received from manager device 120 or employee database 170. Once the position is determined, new hire onboarding wizard 310 can identify the onboarding forms that are associated with the position. The identified onboarding forms are available in onboarding forms database 180. Each identified onboarding form is configured to collect personal information on the new hire. New hire onboarding wizard 310 can determine the missing new hire data by comparing the identified onboarding forms against the new hire data that is available within employee database 170. The new hire data that is missing from employee database 170 but is needed to fill in fields of the identified onboarding forms can be identified as the missing new hire data. Based on the missing new hire data, new hire onboarding wizard can select predefined mobile panels at step (3) (reference numeral (353). In one example, new hire onboarding wizard 310 can select a mobile panel based on the missing new hire data. The mobile panel can include fields for collecting the missing new hire data. In another example, new hire onboarding wizard 310 can examine mobile panels in mobile panels database 190 for a mobile panel which is configured to collect the missing new hire data. If a single mobile panel does not exist, then new hire onboarding wizard 310 can select the minimum number of mobile panels required to collect the missing new hire data.

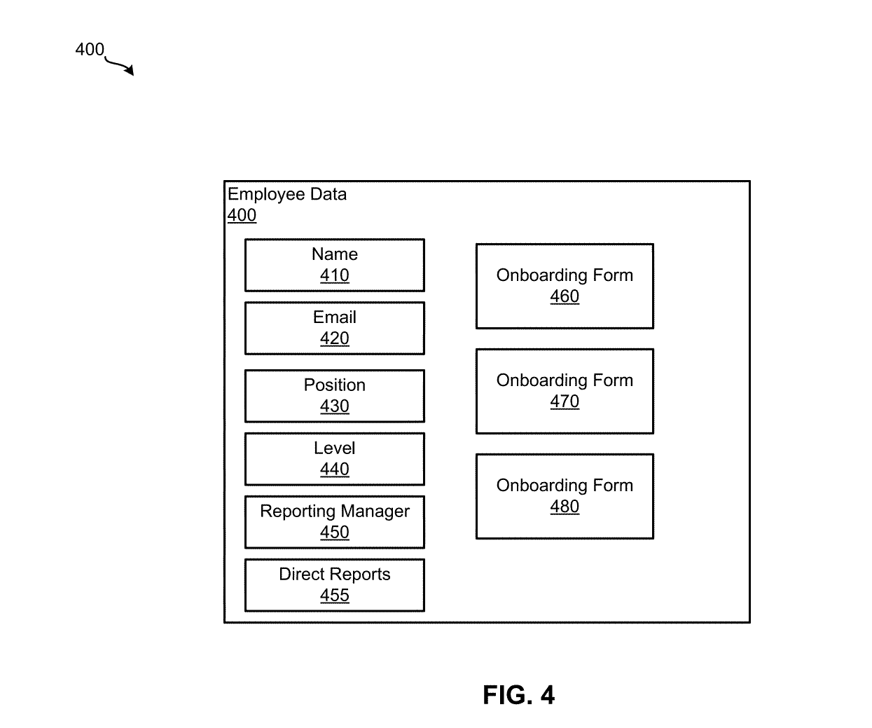

FIG. 4 illustrates an exemplary data structure for storing employee information within an employee database according to one embodiment. Data structure 400 can include multiple data fields for storing information on an employee. Data structure 400 includes name field 410, email field 420, position field 430, level field 440, and reporting manager field 450, and direct reports field 455. Besides data fields, data structure 400 can store documentation on the employee. For example, onboarding forms which have been signed by the employee can be stored as part of the employee's personal file. For instance, voided checks for direct deposit, signed forms confirming that the employee is aware of operating procedures and acceptable work behavior can be stored. Here, data structure 400 includes onboarding forms 460, 470, and 480. Each onboarding form can be a document file or an image file.

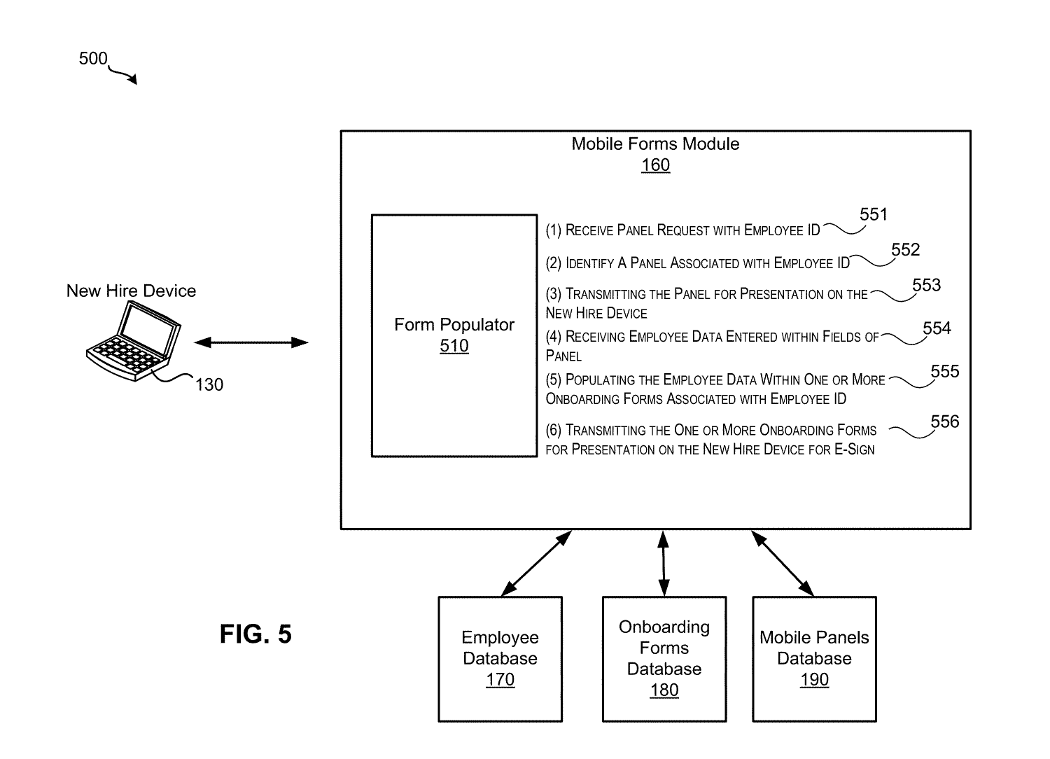

FIG. 5 illustrates a system for generating onboarding forms according to one embodiment. System 500 includes new hire device 130, mobile forms module 160, employee database 170, onboarding forms database 180, and mobile panels database 190. Mobile forms module 160 can include form populator 510 which is configured to present mobile panels to new hire device 130 for purposes of collecting missing new hire data. Once the missing new hire data has been collected, form populator 510 can populate the missing new hire data (and optionally already available new hire data) into one or more onboarding forms. The populated onboarding forms can be transmitted to new hire device 130 to be presented to the new hire. In some embodiments, the new hire can review and electronically sign the onboarding documents. Once signed, new hire device 130 can transmit the signed onboarding documents to mobile forms module 160 which can in turn save the signed onboarding documents within employee database 170.

As shown here, form populator 310 can begin by receiving a panel request at step (1) (reference numeral 551). The panel request can originate from new hire device 130 and contain an employee ID used to uniquely identify the new hire operating new hire device 130. Form populator 510 can then identify one or more mobile panels associated with the employee ID at step (2) (reference numeral 552). In one embodiment, the mobile panels have been associated with the employee ID at an earlier stage, for example by new hire onboarding wizard 310 in FIG. 3. In one example, form populator 510 can query mobile panels database 190 or employee database 170 for a listing of mobile panels which are associated with the employee ID. Form populator 170 can retrieve the identified mobile panels from mobile panels database 190. Each mobile panel can include one or more fields for requesting personal information from the new hire. Form populator 510 can transmit the mobile panels to new hire device 130 for presentation on new hire device 130 at step (3) (reference numeral 553). The mobile panels can be presented on new hire device 130 where the new hire can enter personal information into the mobile panels through new hire device 130. Once the personal information has been entered into the mobile panels, new hire device 130 can transmit the mobile panels back to form populator 510. Form populator 510 can receive the employee data entered into the fields of the mobile panel at step (4) (reference numeral 554). Form populator 510 can populate the employee data found in the mobile forms to one or more onboarding forms associated with the employee ID at step (5) (reference numeral 555). Populating the employee data can include entering the employee data into the onboarding forms. Once the onboarding forms have been populated, form populator 150 can transmit the populated forms to new hire device 130 for review. In one embodiment, form populator 150 can render the onboarding form into a fixed image that cannot be edited by the new hire. Rendering the onboarding form can include fixing the fields of the onboarding form such that they cannot be edited after rendering. This can be similar to providing a printed copy of a document such that the contents of the document cannot be edited. As a result, the new hire cannot modify the contents of the onboarding form. This allows the onboarding form to be reviewed by not edited by the new hire after rendering. The rendered form can be electronically signed in some embodiments. In some examples, a new hire operating new hire device 130 can provide an electronic signature on the populated onboarding forms. The signed populated forms can in turn be transmitted back to form populator 510 for storage within employee database 170.

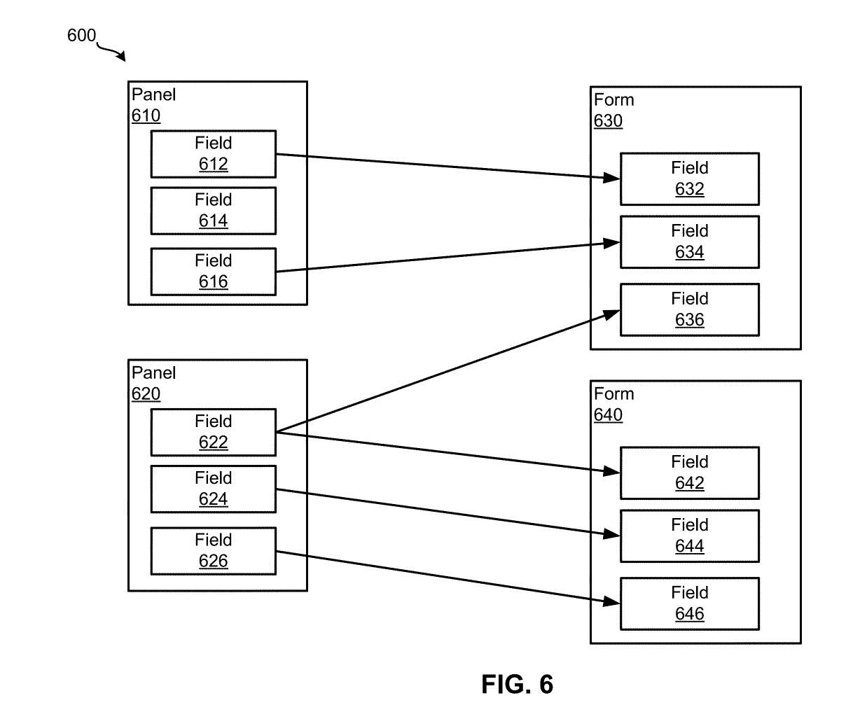

FIG. 6 illustrates a technique for populating data fields within mobile panels to onboarding forms according to one embodiment. As shown here, panel 610 and 620 include data stored within data fields. Form populator 510 can populate data stored within data fields having the same name or identifier from the mobile panels into corresponding data fields in the onboarding forms. As shown, field 612 within panel 610 can be mapped to field 632 within form 630. Similarly, field 616 within panel 610 can be mapped to field 634 within form 630. Some fields that do not have a corresponding field within the identified onboarding forms can be skipped. For example, field 614 in panel 610 does not have a corresponding field in form 630 or form 640. In some examples, form populator 510 can examine mobile panels for fields which do not need to be mapped to an onboarding form. A field in the mobile panel which does not need to be mapped to an onboarding form can be presented as an optional field within the mobile panel or alternatively, can be removed from the mobile panel.

In some examples, a field on a mobile panel can be mapped to multiple fields in multiple onboarding forms. For instance, field 622 of panel 620 is mapped to field 636 of form 630 and field 642 of form 640. Many onboarding forms may store basic information on the new hire such as name, address, and social security number. It can be advantageous to map this common information from a mobile panel into multiple onboarding forms to reduce the likelihood of the new hire making mistakes entering this common information. This can reduce the number of errors in the onboarding forms. Field 624 of panel 620 is mapped to form 644 of form 640. Similarly, field 626 of panel 620 is mapped to form 646 of form 640.

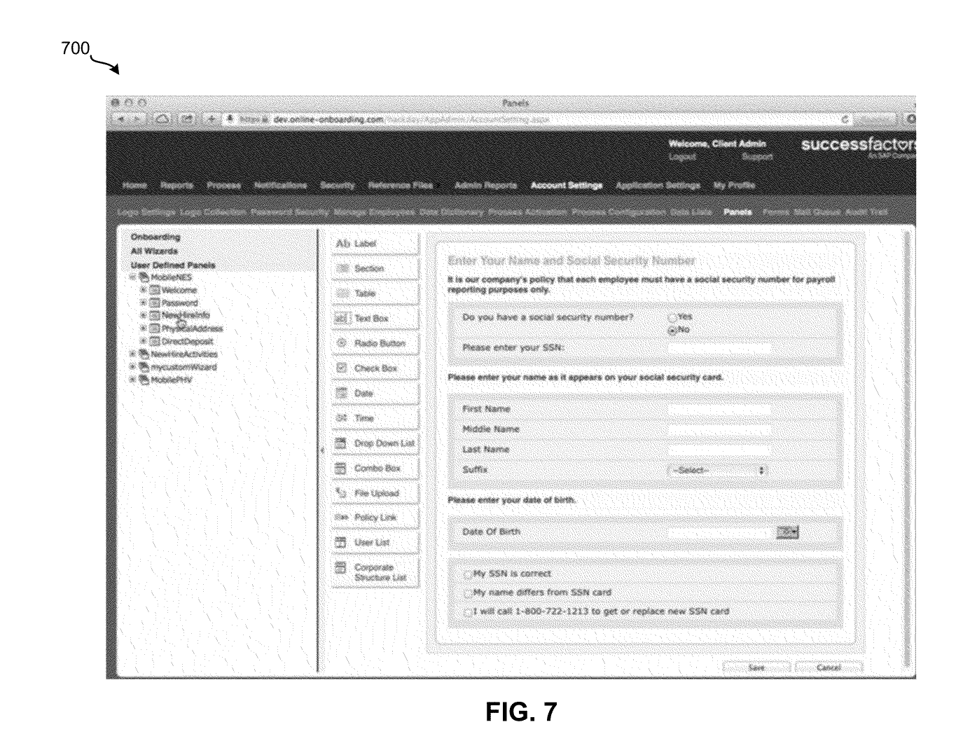

FIG. 7 illustrates a mobile panel designer window according to one embodiment. Mobile panel designer window 700 can be a window generated by mobile panels designer module 210 of FIG. 2. Mobile panel designer window 700 includes a menu on the left hand side which lists a plurality of user defined panels (i.e., mobile panels). Selection of a user defined panel in the menu can result in mobile panel designer module presenting the selected user defined panel on the right hand side of window 700. In some embodiments, window 700 can be configured to receive user input to edit the selected user defined panel. For example, an administrator can provide modifications to mobile panels designer module 210 to modify a mobile panel. The modifications to the mobile panel can be presented in the right hand side of window 700.

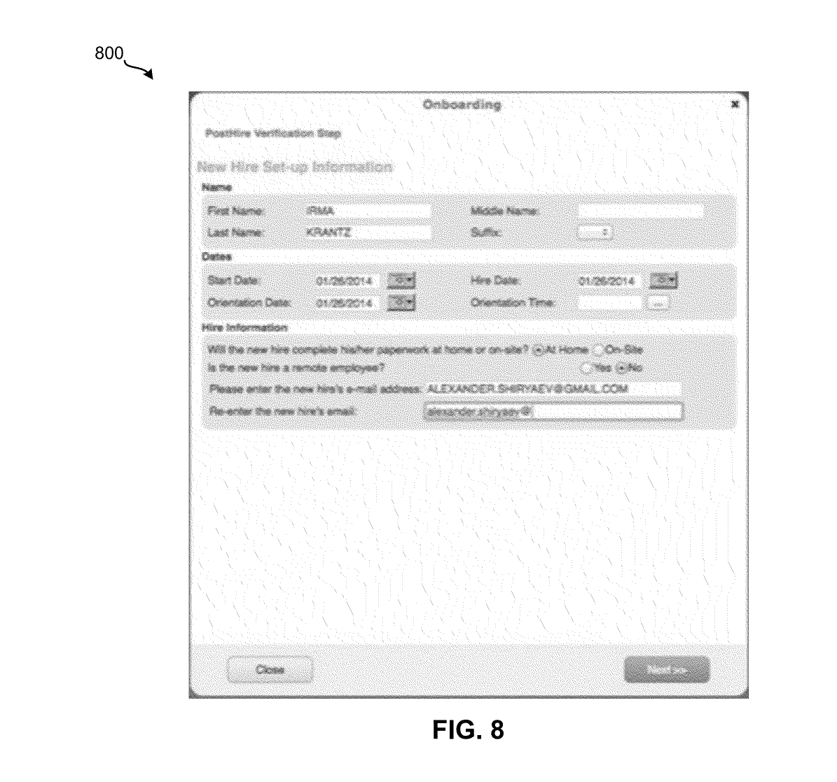

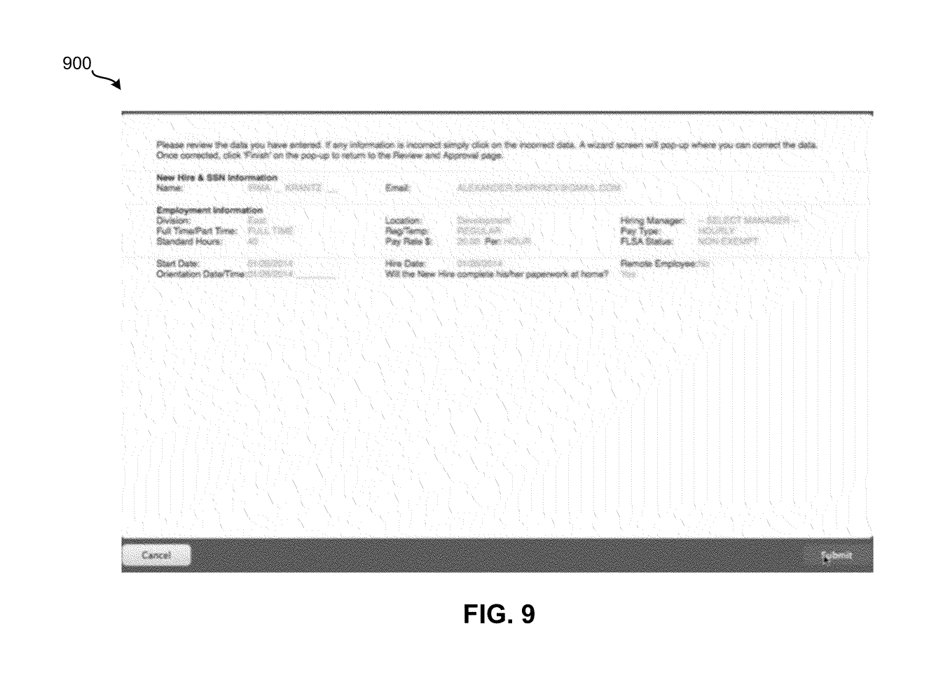

FIG. 8 illustrates a new hire onboarding wizard window according to one embodiment. New hire onboarding wizard window 800 can be generated by new hire onboarding wizard 310 of FIG. 3. Window 800 includes a plurality of fields for setting up a new hire. As shown, window 800 can include a plurality of fields. The manager of the new hire can enter details on the new hire into one or more of the plurality of fields. As shown, the manager may have entered the name, start date, orientation date, hiring date, and hiring information on the new hire. A manager can enter personal information of the new hire which is available to the manager. Details such as the new hire's name, start date, and hire date can be entered. In one embodiment, the manager can enter the email address of the new hire. This allows new hire onboarding wizard 310 to generate an email to the new hire. The new hire can welcome the new hire to the organization and notify the new hire that additional onboarding data is needed. FIG. 9 illustrates a summary page of the new hire onboarding wizard according to one embodiment. As shown, a summary of the information provided by the manager for the new hire is presented for manager review before submitting the onboarding request.

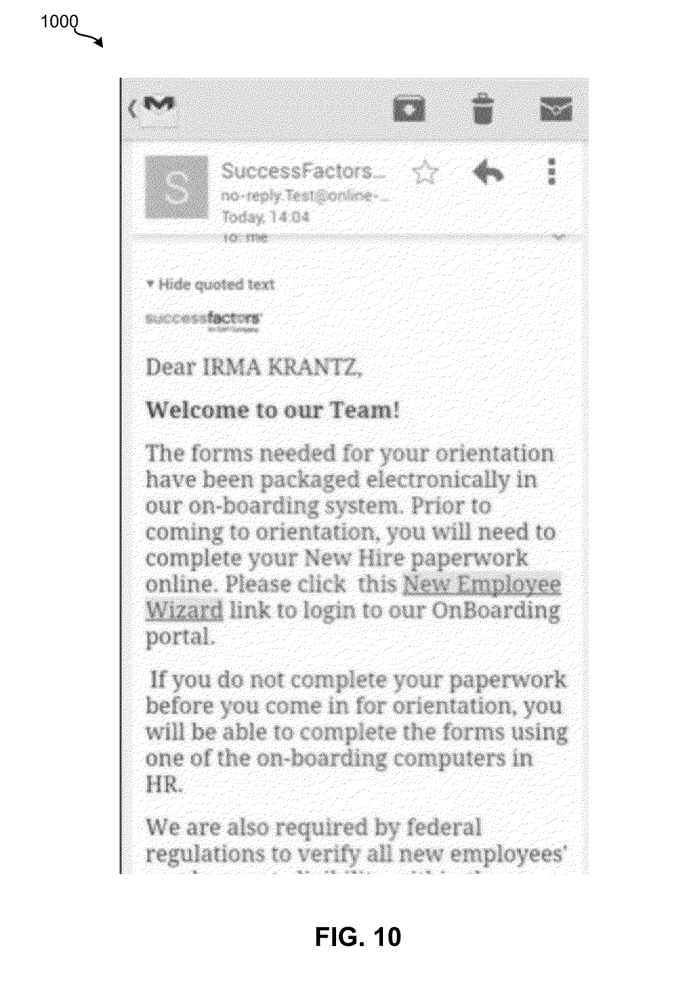

FIG. 10 illustrates an introduction email according to one embodiment. New hire onboarding wizard 310 can generate and transmit email 1000 to an email account associated with the new hire. Email 1000 can be presented on a mobile device operated by the new hire. In one embodiment, new hire information provided by the manager can be used to populate email 1000. For example, email 1000 can be transmitted to the email address specified by the manager and can be address to the name provided by the manager. Some portions of email 1000 can be standardized. For example, the text stating “Welcome to our Team!” can be standardized and included by default in each email. In another embodiment, email 1000 can include a link to an onboarding portal where the new hire can enter personal information into mobile forms. The link can be generic where the new hire enters a login and password to access his or her mobile forms. Alternatively, the link can be unique. For example, the link can be embedded with a unique identifier of the new hire. This can allow selection of the link to automatically present the mobile panels associated with the new hire without having the new hire log into the onboarding portal.

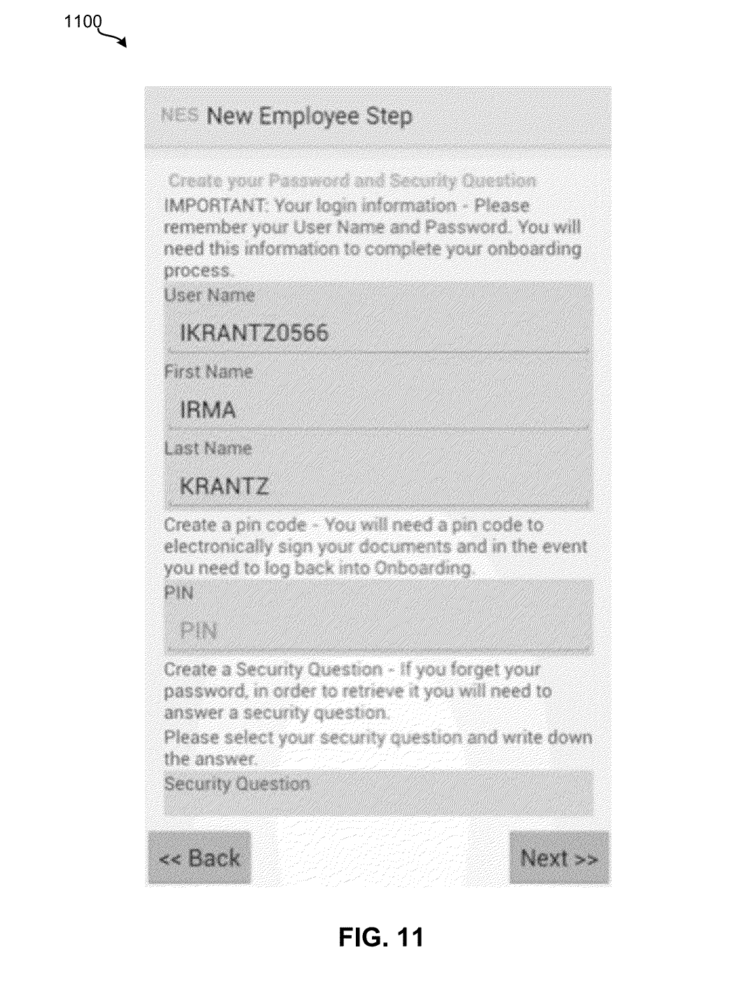

FIG. 11 illustrates a mobile panel according to one embodiment. Mobile panel 1100 includes one or more fields. For example, mobile panel 1100 includes user name, first name, last name, PIN, and security question fields. In one embodiment, a plurality of fields can be automatically populated with new hire data that is available to the organization. The new hire data can be entered by the manager through the onboarding wizard or alternatively by an administrator of the organization. This can provide an opportunity for the new hire to review the new hire data and make changes, if necessary. Other fields such as the PIN field and the Security Question field can be empty and need to be populated by the new hire.

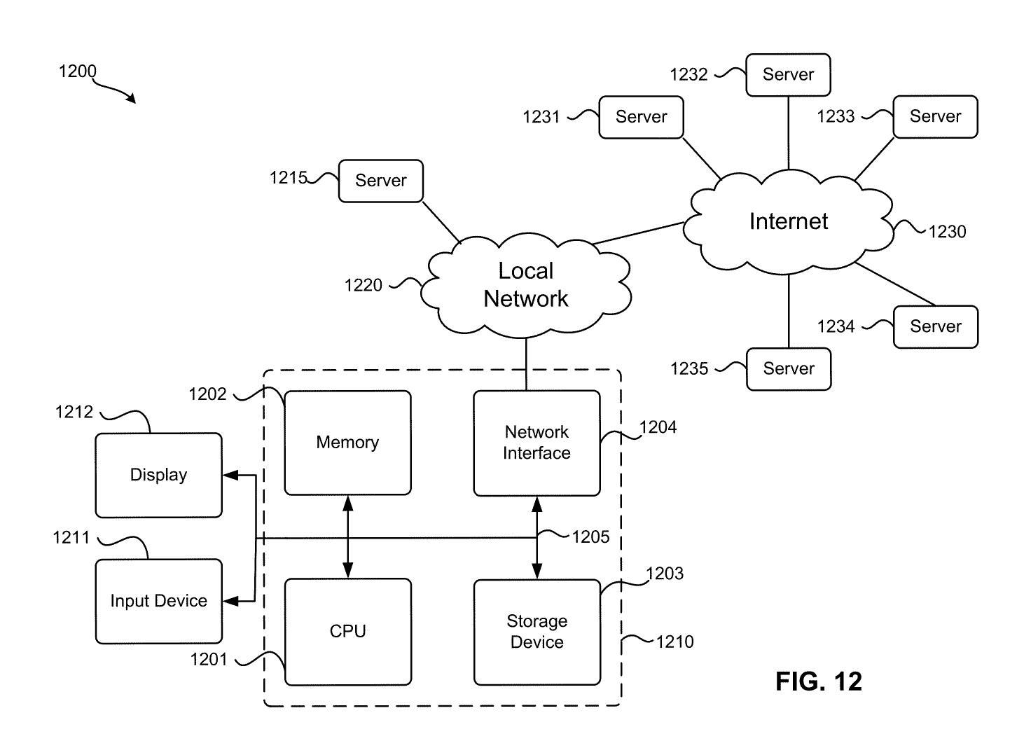

An exemplary computer system 1200 is illustrated in FIG. 12. Computer system 1210 includes a bus 1205 or other communication mechanism for communicating information, and a processor 1201 coupled with bus 1205 for processing information. Computer system 1210 also includes memory 1202 coupled to bus 1205 for storing information and instructions to be executed by processor 1201, including information and instructions for performing the techniques described above, for example. This memory may also be used for storing variables or other intermediate information during execution of instructions to be executed by processor 1201. Possible implementations of this memory may be, but are not limited to, random access memory (RAM), read only memory (ROM), or both. A storage device 1203 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1203 may include source code, binary code, or software files for performing the techniques above, for example. Storage device and memory are both examples of computer readable mediums.

Computer system 1210 may be coupled via bus 1205 to a display 1212, such as a cathode ray tube (CRT) or liquid crystal display (LCD), for displaying information to a computer user. An input device 1211 such as a keyboard and/or mouse is coupled to bus 1205 for communicating information and command selections from the user to processor 1201. The combination of these components allows the user to communicate with the system. In some systems, bus 1205 may be divided into multiple specialized buses.

Computer system 1210 also includes a network interface 1204 coupled with bus 1205. Network interface 1204 may provide two-way data communication between computer system 1210 and the local network 1220. The network interface 1204 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1204 sends and receives electrical, electromagnetic, or optical signals that carry digital data streams representing various types of information.

Computer system 1210 can send and receive information, including messages or other interface actions, through the network interface 1204 across a local network 1220, an Intranet, or the Internet 1230. For a local network, computer system 1210 may communicate with a plurality of other computer machines, such as server 1215. Accordingly, computer system 1210 and server computer systems represented by server 1215 may form a cloud computing network, which may be programmed with processes described herein. In the Internet example, software components or services may reside on multiple different computer systems 1210 or servers 1231-1235 across the network. The processes described above may be implemented on one or more servers, for example. A server 1231 may transmit actions or messages from one component, through Internet 1230, local network 1220, and network interface 1204 to a component on computer system 1210. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method, comprising:
receiving, by a processor, a request to complete at least one employment form associated with an employee;
identifying, by the processor, a mobile panel configured to receive employee data that is associated with the employee;
transmitting, by the processor, the mobile panel to a mobile device operated by the employee;
receiving, by the processor, the employee data through the mobile panel;
populating, by the processor, the at least one employment form with the employee data;
rendering, by the processor, the at least one populated employment form into at least one rendered image; and
transmitting, by the processor, the at least one rendered image to the mobile device operated by the employee.

2. The computer-implemented method of claim 1, further comprising:
receiving, by the processor, an electronic signed copy of the at least one rendered image; and
associating, by the processor, the electronic signed copy of the at least one rendered image to an employee account of the employee.

3. The computer-implemented method of claim 1, wherein the request is generated from the selection of a link provided in an email.

4. The computer-implemented method of claim 1, wherein identifying the panel comprises:
identifying, by the processor, an empty field within an employment form of the at least one employment form; and
determining, by the processor, the mobile panel includes a field for receiving the employee data that corresponds with the empty field within the employment form.

5. The computer-implemented method of claim 1, further comprising:
matching, by the processor, the employee data to another employment form; and
populating, by the processor, the employee data within the another employment form.

6. The computer-implemented method of claim 1, further comprises:
storing, by the processor, the employee data within a data structure associated with the employee.

7. The computer-implemented method of claim 1, wherein at least one field within the mobile panel is prepopulated with information available on the employee.

8. A non-transitory computer readable storage medium storing one or more programs, the one or more programs comprising instructions for:
receiving a request to complete at least one employment form associated with an employee;
identifying a mobile panel configured to receive employee data that is associated with the employee;
transmitting the mobile panel to a mobile device operated by the employee;
receiving the employee data through the mobile panel;
populating the at least one employment form with the employee data;
rendering the at least one populated employment form into at least one rendered image; and
transmitting the at least one rendered image to the mobile device operated by the employee.

9. The non-transitory computer readable storage medium of claim 8, further comprising:
receiving an electronic signed copy of the at least one rendered image; and
associating the electronic signed copy of the at least one rendered image to an employee account of the employee.

10. The non-transitory computer readable storage medium of claim 8, wherein the request is generated from the selection of a link provided in an email.

11. The non-transitory computer readable storage medium of claim 8, wherein identifying the panel comprises:
identifying an empty field within an employment form of the at least one employment form; and
determining the mobile panel includes a field for receiving the employee data that corresponds with the empty field within the employment form.

12. The non-transitory computer readable storage medium of claim 8, further comprising:
matching the employee data to another employment form; and
populating the employee data within the another employment form.

13. The non-transitory computer readable storage medium of claim 8, further comprises:
storing the employee data within a data structure associated with the employee.

14. The non-transitory computer readable storage medium of claim 8, wherein at least one field within the mobile panel is prepopulated with information available on the employee.

15. A computer implemented system, comprising:
one or more computer processors; and
a non-transitory computer-readable storage medium comprising instructions, that when executed, control the one or more computer processors to be configured for:
receiving a request to complete at least one employment form associated with an employee;
identifying a mobile panel configured to receive employee data that is associated with the employee;
transmitting the mobile panel to a mobile device operated by the employee;
receiving the employee data through the mobile panel;
populating the at least one employment form with the employee data;
rendering the at least one populated employment form into at least one rendered image; and
transmitting the at least one rendered image to the mobile device operated by the employee.

16. The computer implemented system of claim 15, further comprising:
receiving an electronic signed copy of the at least one rendered image; and
associating the electronic signed copy of the at least one rendered image to an employee account of the employee.

17. The computer implemented system of claim 15, wherein identifying the panel comprises:
identifying an empty field within an employment form of the at least one employment form; and
determining the mobile panel includes a field for receiving the employee data that corresponds with the empty field within the employment form.

18. The computer implemented system of claim 15, further comprising:
matching the employee data to another employment form; and
populating the employee data within the another employment form.

19. The computer implemented system of claim 15, further comprises:
storing the employee data within a data structure associated with the employees.

20. The computer implemented system of claim 15, wherein at least one field within the mobile panel is prepopulated with information available on the employee.
